(19) United States
(12) Patent Application Publication
(10) Pub. No.: US 2013/0071023 A1
(43) Pub. Date: Mar. 21, 2013

(54) COLOR PROCESSING APPARATUS, COLOR PROCESSING METHOD, AND COMPUTER-READABLE NON-TRANSITORY TANGIBLE MEDIUM

(71) Applicant: Makoto SASAKI, Kanagawa (JP)

(72) Inventor: Makoto SASAKI, Kanagawa (JP)

(73) Assignee: FUJI XEROX CO., LTD., Tokyo (JP)

(21) Appl. No.: 13/366,020

(22) Filed: Feb. 3, 2012

(30) Foreign Application Priority Data
Sep. 21, 2011 (JP) 2011-206264

(51) Int. Cl. G06K 9/00

(52) U.S. Cl. 382/167; 382/162

(57) ABSTRACT

A color processing apparatus for decomposing a color signal into an output color signal including a basic-color component, a black component, and an extra-color component is provided. The color processing apparatus includes an extra-color-component upper-limit-value determination unit that determines an extra-color-component upper limit value, a black-component upper-limit-value determination unit that determines a black-component upper limit value, a black-component-value determination unit that determines a value of the black component corresponding to the color signal, an extra-color-component-value determination unit that determines a value of the extra-color component corresponding to the color signal, and a basic-color-component-value determination unit that determines a value of the basic-color component corresponding to the color signal on the basis of the value of the black component and the value of the extra-color component.

### CROSS-REFERENCE TO RELATED APPLICATIONS

This application is based on and claims priority under 35 USC 119 from Japanese Patent Application No. 2011-206264 filed Sep. 21, 2011.

### BACKGROUND

(i) Technical Field

The present invention relates to a color processing apparatus, a color processing method, and a computer-readable non-transitory tangible medium.

(ii) Related Art

Multiple colors are used when output devices output color images. In typical color output devices of the related art, cyan (C), magenta (M), and yellow (Y), which are basic colors, are used, and, in addition to CMY, black (K) is used. In recent years, further, extra colors other than K are used in some cases. For example, the cases in which extra colors other than K are used are as follows: five colors that are obtained by adding orange (O) to the four colors which are CMYK are used; six colors that are obtained by further adding green (G), i.e., CMYKOG, are used; and seven colors that are obtained by further using violet (V), i.e., CMYKOGV, or CMYKRGB (red being denoted by R, green being denoted by G, blue being denoted by B), are used. In such cases, the output devices receive color signals, and convert the color signals into color signals having dimensions, the number of dimensions being the number of colors that are to be used.

### SUMMARY

According to an aspect of the invention, there is provided a color processing apparatus for performing color decomposition of a color signal into an output color signal. The color signal is input, and the output color signal includes a basic-color component, a black component, and an extra-color component. The color processing apparatus includes an extra-color-component upper-limit-value determination unit, a black-component upper-limit-value determination unit, a black-component-value determination unit, an extra-color-component-value determination unit, and a basic-color-component-value determination unit. The extra-color-component upper-limit-value determination unit determines an extra-color-component upper limit value. The extra-color-component upper limit value is a value of the extra-color component corresponding to a maximum value of the black component which is obtainable using the color decomposition of the color signal. The black-component upper-limit-value determination unit determines a black-component upper limit value. The black-component upper limit value is a maximum value of the black component corresponding to a minimum value of the extra-color component which is obtainable using the color decomposition of the color signal. The black-component-value determination unit determines a value of the black component corresponding to the color signal. The value of the black component is equal to or smaller than the black-component upper limit value. The extra-color-component-value determination unit determines a value of the extra-color component corresponding to the color signal. The value of the extra-color component is equal to or smaller than the extra-color-component upper limit value. The basic-color-component-value determination unit determines a value of the basic-color component corresponding to the color signal on the basis of the value of the black component, which has been determined by the black-component-value determination unit, and the value of the extra-color component, which has been determined by the extra-color-component-value determination unit.

### BRIEF DESCRIPTION OF THE DRAWINGS

Exemplary embodiment(s) of the present invention will be described in detail based on the following figures,

wherein:

FIG. 1 is a configuration diagram illustrating an exemplary embodiment of the present invention;

FIGS. 2A to 2D are explanatory diagrams illustrating examples of used values of a black component and an extra-color component other than the black component in a color gamut of an output device;

FIG. 3 is an explanatory diagram illustrating an example of a range of existence of the black component and the extra-color component included in a certain color;

FIG. 4 is an explanatory diagram illustrating an example of a range of use of the black component and the extra-color component;

FIGS. 5A to 5C are explanatory diagrams illustrating other examples of the range of use of the black component and the extra-color component;

FIGS. 6A to 6C are explanatory diagrams illustrating examples of methods for determining a black-component upper limit value and an extra-color-component upper limit value or, in addition thereto, a black-component lower limit value and an extra-color-component lower limit value;

FIG. 7 is a configuration diagram illustrating a first modification example of the exemplary embodiment of the present invention;

FIGS. 8A and 8B are explanatory diagrams illustrating examples of problems with color continuity, which are caused by values of the extra-color component;

FIGS. 9A to 9D are explanatory diagrams illustrating examples of control of the black component and the extra-color component that is performed so as to guarantee color continuity;

FIGS. 10A and 10B are explanatory diagrams illustrating examples of functions that control the value of the extra-color component so as to guarantee color continuity;

FIGS. 11A to 11C are explanatory diagrams illustrating an example of control of the extra-color component on the basis of brightness;

FIGS. 12A and 12B are explanatory diagram illustrating an example of control of the extra-color component on the basis of a distance from a white point;

FIG. 13 is a configuration diagram illustrating a second modification example of the exemplary embodiment of the present invention;

FIG. 14 is a configuration diagram illustrating a third modification example of the exemplary embodiment of the present invention;

FIG. 15 is a configuration diagram illustrating a fourth modification example of the exemplary embodiment of the present invention;

FIG. 16 is a configuration diagram illustrating a fifth modification example of the exemplary embodiment of the present invention; and

FIG. 17 is an explanatory diagram illustrating examples of a computer program, a storage medium that stores the computer program, and a computer in a case in which functions described in the exemplary embodiment of the present invention and the modification examples thereof are realized by the computer program.

### DETAILED DESCRIPTION

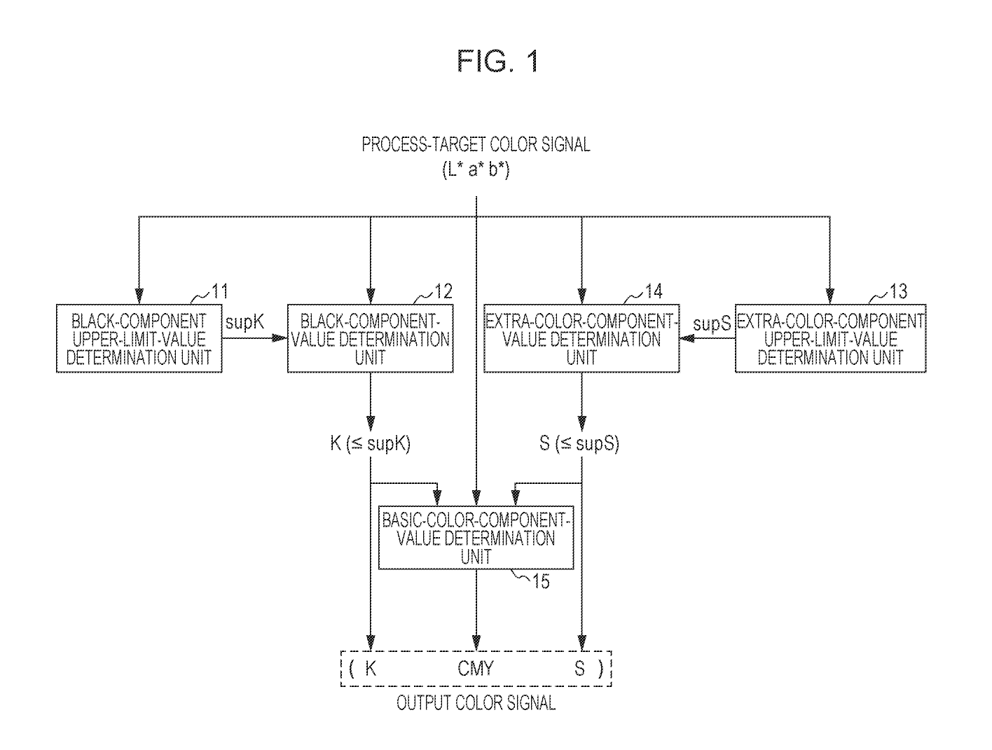

FIG. 1 is a configuration diagram illustrating an exemplary embodiment of the present invention. It is supposed that a process-target color signal provided in this example is a color signal in a device-independent color space. It is supposed that a color signal in an LAB color space is provided as an example of the process-target color signal. As a matter of course, the process-target color signal may be a color signal in a device-independent color space other than the LAB color space. Furthermore, it is supposed that an output color signal includes basic-color components, a black component, and an extra-color component. It is supposed that C, M, and Y are provided as examples of the basic-color components. As a mater of course, the basic-color components are not limited to C, M, and Y. The basic-color components may be a combination of other color components constituting color image, such as R, G, and B. Note that the black component is denoted by K, and the extra-color component is denoted by S. The extra-color component S is a color component other than the basic-color components and the black component, and may be an extra-color component of one of various extra colors such as O, G, V, R, and B. The extra color (or it can be called as additional color) is used to expand the color gamut. Some of spot colors may be used for an extra color if it can expand the color gamut.

A black-component upper-limit-value determination unit 11 determines, as a black-component upper limit value, a maximum value of the black component in a case in which the extra-color component is minimized. Regarding determination of the black-component upper limit value, for example, a model that determines the black-component upper limit value from the process-target color signal may be configured, and a configuration in which the black-component upper limit value is determined using this model may be used.

A black-component-value determination unit 12 determines a value of the black component of the output color signal so that the value of the black component of the output color signal is in a range of the black-component upper limit value, which has been determined by the black-component upper-limit-value determination unit 11, or less. Note that, for a color for which a lower limit value of the black component exists, the black-component-value determination unit 12 determines a value of the black component of the output color signal so that the value of the black component of the output color signal is in a range of the lower limit value to the black-component upper limit value. Various methods have been proposed in the related art as methods for determining a value of the black component. The methods may be employed.

An extra-color-component upper-limit-value determination unit 13 determines, as an extra-color-component upper limit value, a value of the extra-color component in a case in which the value of the black component is maximized while the extra-color component is being used. The details of the extra-color-component upper limit value will be described below. Regarding determination of the extra-color-component upper limit value, for example, a model that determines the extra-color-component upper limit value from the process-target color signal may be configured, and a configuration in which the extra-color-component upper limit value is determined using this model may be used.

An extra-color-value determination unit 14 determines a value of the extra-color component of the output color signal so that the value of the extra-color component of the output color signal is in a range of the extra-color-component upper limit value, which has been determined by the extra-color-component upper-limit-value determination unit 13, or less. Note that, for a color for which a lower limit value of the extra-color component exists, the extra-color-value determination unit 14 determines a value of the extra-color component of the output color signal so that the value of the extra-color component of the output color signal is in a range of the lower limit value to the extra-color-component upper limit value. The extra-color-value determination unit 14 determines a value of the extra-color component independently of determination of a value of the black component with the black-component-value determination unit 12. Although a method for determining a value of the extra-color component is not particularly limited, some methods will be described below.

A basic-color-component-value determination unit 15 determines individual values of the basic-color components of the output color signal from the process-target color signal, which has been provided, the value of the black component, which has been determined by the black-component-value determination unit 12, and the value of the extra-color component, which has been determined by the extra-color-value determination unit 14. Mathematically, a four-or-more dimensional output color signal is not uniquely determined from a three-dimensional color signal in a device-independent color space. However, because a value of the black component and a value of the extra-color component are determined, conversion in which a three-dimensional color signal is obtained from a five-or-more-dimensional color signal is performed. Thus, the output color signal is uniquely obtained.

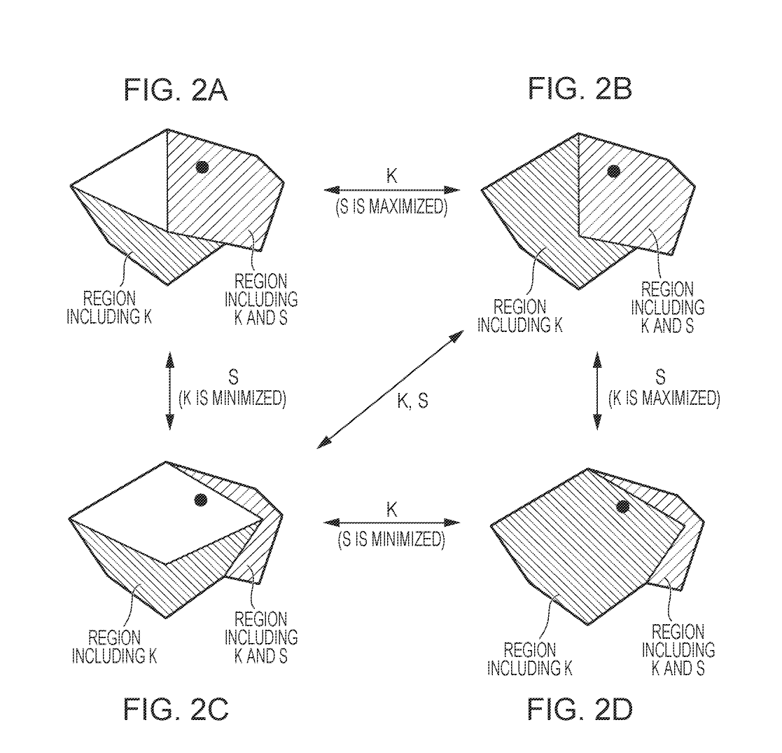

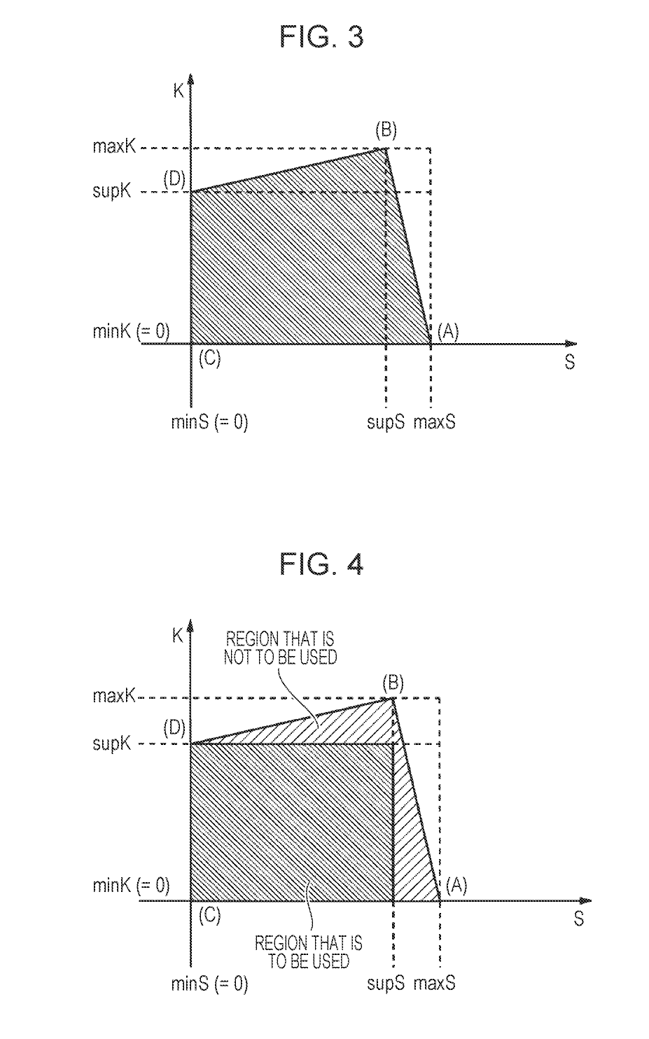

FIGS. 2A to 2D are explanatory diagrams illustrating examples of used values of the black component and the extra-color component other than the black component in a color gamut of an output device. FIG. 3 is an explanatory diagram illustrating an example of a range of existence of the black component and the extra-color component included in a certain color. In FIGS. 2A to 2D, color regions that are reproduced by a certain output device are illustrated in a device-independent color space, and illustrated with respect to a certain plane including a brightness axis. FIG. 2A illustrates a case in which the black component is minimized and the extra-color component is maximized. FIG. 2B illustrates a case in which the black component and the extra-color component are maximized. FIG. 2C illustrates a case in which the black component and the extra-color component are minimized. FIG. 2D illustrates a case in which the black component is maximized and the extra-color component is minimized. Furthermore, a color region filled with lines sloping downward from left to right represents a region that includes the black component and that does not include the extra-color component other than the black component. A color region filled with lines sloping upward from left to right represents a region that includes at least the extra-color component. A region that is not filled with sloping lines represents a region that does not include either the black component or the extra-color component other than the black component.

As illustrated in FIG. 2C, in a case in which the black component and the extra-color component are not used, only the color region that is not filled with sloping lines is reproduced. However, a color region including not only the color region that is not filled with sloping lines and but also the color region filled with lines sloping downward from left to right is reproduced by using the black component. A color region including not only the color region that is not filled with sloping lines and the color region filled with lines sloping downward from left to right but also the color region filled with lines sloping upward from left to right is reproduced by further using the extra-color component. Multiple combinations of the individual color components that are combinations for reproducing colors in the color region exist.

Regarding a color indicated by a black circle in FIGS. 2A to 2D, a range of existence of the black component and the extra-color component is illustrated in FIG. 3. In the case which is illustrated in FIG. 2C and in which the black component and the extra-color component are minimized, both the black component and the extra-color component are zero in the example of this color. In other words, the minimum value of the black component and the minimum value of the extra-color component in the color are zero. The case which is illustrated in FIG. 2D and in which the black component is maximized and the extra-color component is minimized is denoted by (D) in FIG. 3. The value of the black component in the case is denoted by supK. Furthermore, the case which is illustrated in FIG. 2A and in which the black component is minimized and the extra-color component is maximized is denoted by (A) in FIG. 3. In the case, the value of the black component is zero, and the value of the extra-color component is denoted by maxS.

The case which is illustrated in FIG. 2B and in which the black component and the extra-color component are maximized is denoted by (B) in FIG. 3. In a case of first determining a value of the black component in the related art, a value of the black component in a case in which the extra-color component is minimized is determined. Accordingly, a value of the black component is determined so as to be in a range from zero to supK, and is fixed. However, when an extra color for increasing the color gamut is added, the maximum value of the black component increases with increasing value of the extra-color component of the extra color. For example, when CMYK and R that serves as an extra-color component are used, colors that are reproduced using CMYK and YMRK exist. Accordingly, there is a property that, although a maximum value of the black component is uniquely determined in a case in which the value of the extra-color component is minimized (for example, zero), the maximized value of the black component changes in accordance with the value of the extra-color component in a case in which the extra-color component is included. In other words, the maximum value of the black component in the case in which the extra-color component is included increases with increasing value of the extra-color component. The value of the black component in the case illustrated in FIG. 2B is larger than the value of the black component in the case illustrated in FIG. 2D. The value of the black component in the case illustrated in FIG. 2B is denoted by maxK, and the value of the extra-color component in the case is denoted by supS.

In contrast, the value of the black component in the case illustrated in FIG. 2A is zero, and is different from the value of the extra-color component in the case illustrated in FIG. 2B. In other words, when the value of the black component decreases from the maximum value of the black component in the case illustrated in FIG. 2B, the values of the basic-color components increase instead of the value of the black component. Accordingly, a margin for increasing the value of the extra-color component is generated. Thus, the value of the extra-color component increases as the value of the black component decreases from the value of the black component in the case denoted by (B) in FIG. 3. The case in which the value of the black component is minimized (herein, zero) is the case which is illustrated in FIG. 2A and in which the black component is minimized and the extra-color component is maximized. The case is denoted by (A) in FIG. 3.

For example, in a case of using the black component and the extra-color component to a maximal degree, when the value of the extra-color component is in a range of zero to supS, a value of the black component is determined depending on the value of the extra-color component. Furthermore, when the value of the extra-color component is in a range of supS to maxS, a value of the extra-color component is determined depending on the value of the black component. In other words, an order relation for determining values of the black component and the extra-color component exists.

FIG. 4 is an explanatory diagram illustrating an example of a range of use of the black component and the extra-color component. In FIG. 4, for the color indicated by the black circle in FIGS. 2A to 2D, the range of existence of the black component and the extra-color component, which is illustrated in FIG. 3, is re-illustrated. A region that is to be used in the exemplary embodiment of the present invention is illustrated in such a manner as to be filled with lines sloping downward from left to right, and a region that is not to be used is illustrated in such a manner as to be filled with lines sloping upward from left to right. In a case of using the entirety of the range of existence of the black component and the extra-color component, which is illustrated in FIG. 3, the order relation for determining values of the black component and the extra-color component exists as described above. However, values of the black component and the extra-color component may be determined without considering the order relation, when the value of the black component is limited so as to be equal to or smaller than supK and the value of the extra-color component is limited so as to be equal to or smaller than supS. In other words, in a case in which the value of the extra-color component is equal to or smaller than supS, even when any value in a range of supK or less is determined as a value of the black component, the value of the black component is in the range of existence of the black component. In contrast, in a case in which the value of the black component is equal to or smaller than supK, even when any value in a range of supS or less is determined as a value of the extra-color component, the value of the extra-color component is in the range of existence of the extra-color component. Accordingly, a value of the black component and a value of the extra-color component may be determined independently of each other, when the value of the black component and the value of the extra-color component are in the range which is filled with lines sloping downward from left to right in FIG. 4 and which indicates that the value of the black component is equal to or smaller than supK and the value of the extra-color component is equal to or smaller than supS.

In accordance with the above-described consideration, in the exemplary embodiment of the present invention, the maximum value of the black component in the case in which the extra-color component is minimized, i.e., supK, is determined as the black-component upper limit value by the black-component upper-limit-value determination unit 11. Furthermore, the value of the extra-color component in the case in which the value of the black component is maximized (=maxK) while the extra-color component is being used, i.e., supS, is determined as the extra-color-component upper limit value by the extra-color-component upper-limit-value determination unit 13. The black-component-value determination unit 12 determines a value of the black component so that the value of the black component is in the range of the black-component upper limit value (supK), which has been determined by the black-component upper-limit-value determination unit 11, or less. The extra-color-component-value determination unit 14 determines a value of the extra-color component so that the value of the extra-color component is in the range of the extra-color-component upper limit value (supS), which has been determined by the extra-color-component upper-limit-value determination unit 13, or less. Thus, determination of a value of the black component and determination of a value of the extra-color component are performed independently of each other.

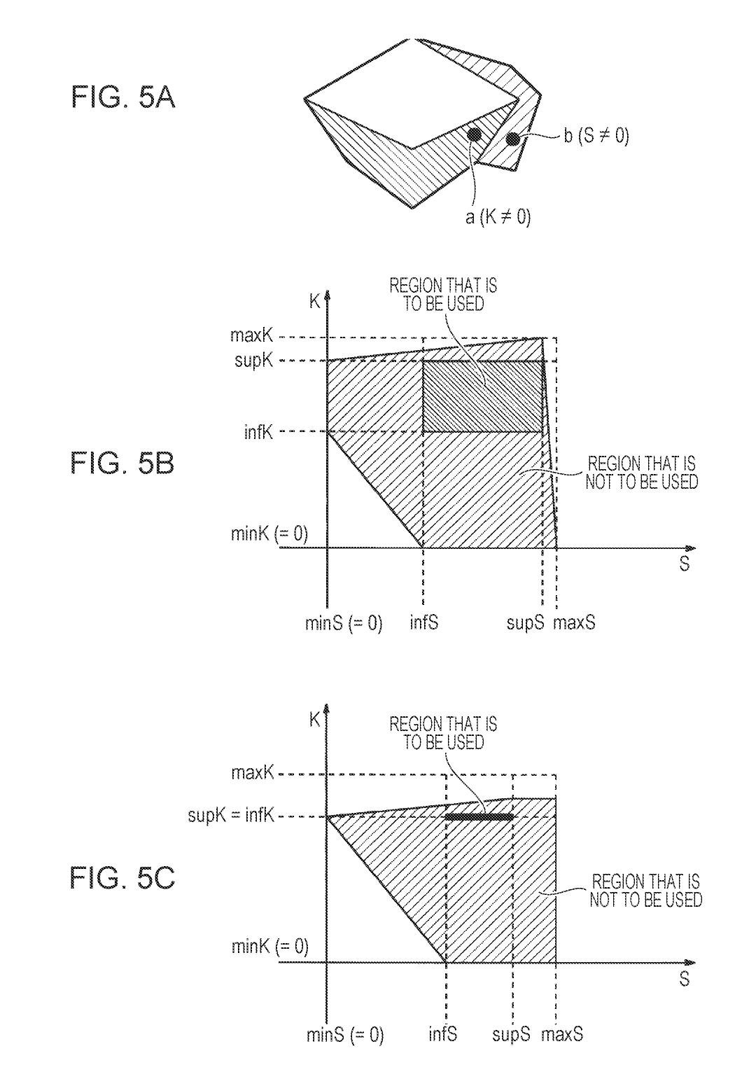

FIGS. 5A to 5C are explanatory diagrams illustrating other examples of the range of use of the black component and the extra-color component. In FIG. 4, an example of the range of use of the black component and the extra-color component for the color which is provided as an example and which is indicated by the black circle in FIGS. 2A to 2D is illustrated. However, there are some colors that are not able to be reproduced by using only the basic-color components. In such a color, the values of the black component and the extra-color component do not become zero. The case which is illustrated in FIG. 2C and in which both the black component and the extra-color component are minimized is illustrated in FIG. 5A. However, a color that is indicated by a black circle denoted by a in FIG. 5A is not able to be reproduced by using only the basic-color components. For example, in a case in which the extra-color component is zero, a lower limit value of the black component exists. A range of existence of the values of the black component and the extra-color component in this case is a range illustrated using solid lines in FIG. 5B. In this example, the minimum value of the black component in a case in which the value of the extra-color component is minimized (zero in the example) is denoted by infK. This value infK is referred to as a black-component lower limit value. Moreover, the minimum value of the extra-color component in a case in which the black component is minimized (zero in the example) is denoted by infS. This value infS is referred to as an extra-color-component lower limit value. In the example, the region of use of the black component and the extra-color component may be a range represented by a relationship infK≦K≦supK and a relationship infS≦S≦supS.

Furthermore, a color that is indicated by a black circle denoted by b in FIG. 5A is also not able to be reproduced by using only the basic-color components. Furthermore, a case is illustrated, in which the color is not able to be reproduced when the value of the extra-color component is zero. The range of existence of the values of the black component and the extra-color component in this case is a range illustrated using solid lines in FIG. 5C. In this example, the values of the black component in a case in which the value of the extra-color component is minimized (minS in the example) are the black-component lower limit value infK and the black-component upper limit value supK. Moreover, the minimum value of the extra-color component in a case in which the black component is minimized (zero in the example) is illustrated as infS (the extra-color-component lower limit value). In the example, the range of use of the black component and the extra-color component may be a range represented by an equation infK=supK and a relationship infS≦S≦supS. For convenience of illustration, the range of use of the black component and the extra-color component is illustrated using bold lines.

Note that rigid adherence to the relationship infK≦K≦supK and the relationship infS≦S≦supS may lead to deterioration of gradation characteristics in image quality design. In such a case, the values of the black component and the extra-color component may be controlled under conditions where the value of the black component K is equal to or smaller than the black-component upper limit value supK and where the value of the extra-color component S is equal to or smaller than the extra-color-component upper limit value supS. Even when the value of the black component K becomes equal to or smaller than infK and the value of the extra-color component S becomes equal to or smaller than infS, minK and minS exist. Accordingly, depending on combinations of values of the black component K and the extra-color component S, when values of the black component K and the extra-color component S are in the range of the value of the black component K and the value of the extra-color component S which is illustrated in such a manner as to be filled with sloping lines in FIG. 5B or 5C, the color is reproduced, and determined values of the basic-color components fall within a range that is set in advance. As described above, even when the value of the black component K and the value of the extra-color component S are in a range that is illustrated as a “region that is not to be used” in FIG. 5B or 5C, the color is reproduced. The value of the black component K and the value of the extra-color component S may be basically controlled in a range that is illustrated as a “region that is to be used” in FIG. 5B or 5C, and may be controlled in the entirety of the region filled with sloping lines, while image quality is being considered. When the value of the black component K and the value of the extra-color component S are outside the region filled with sloping lines, determined values of the basic-color components fall outside the range that is set in advance (a region outside the color gamut). In such a case, for values of the black component K and the extra-color component S which are to be used, color values (for example, L*a*b values) may be compressed in advance by a process, such as a color-gamut compression process, so as to determine values of the basic-color components that are in the range which is set in advance. Alternatively, exceeding portions of the values of the basic-color components may be clipped. As a matter of course, by using the black-component lower limit value infK and the extra-color-component lower limit value infS, values of the basic-color components are made to fall within the range that is set in advance.

Regarding the black-component upper limit value supK and the extra-color-component upper limit value supS or, in addition thereto, the black-component lower limit value infK and the extra-color-component lower limit value infS, which are described above, models (functions) that determine the individual values from the process-target color signal are configured in advance, and the individual values may be determined using the models. For example, in a case in which the process-target color signal is represented by L*a*b* values, the black-component upper limit value supK may be obtained using a model that converts L*a*b* values into the black-component upper limit value supK. Additionally, the black-component lower limit value infK may be obtained using a model that converts L*a*b* values into the black-component lower limit value infK. The extra-color-component upper limit value supS may be obtained using a model that converts L*a*b* values into the extra-color-component upper limit value supS. The extra-color-component lower limit value infS may be obtained using a model that converts L*a*b* values into the extra-color-component lower limit value infS.

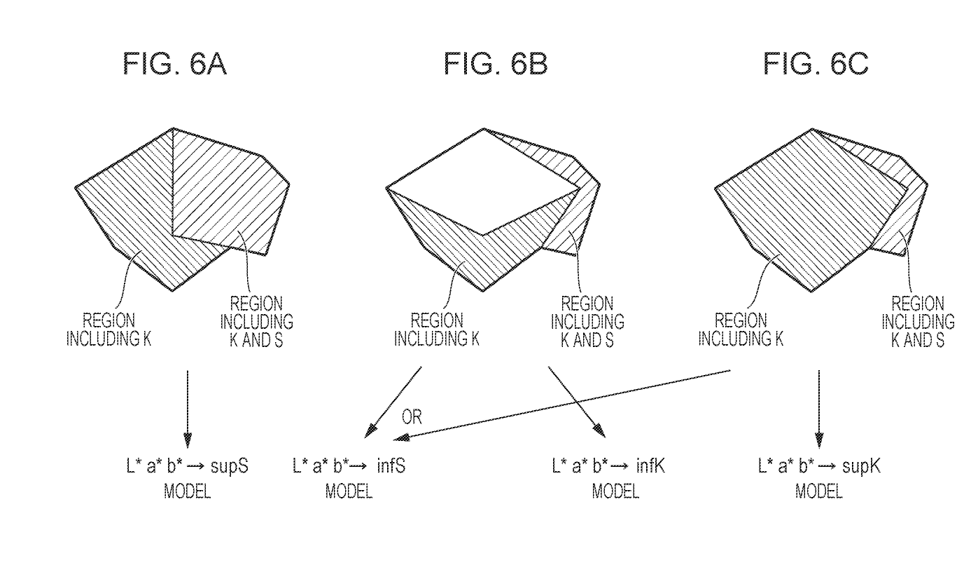

FIGS. 6A to 6C are explanatory diagrams illustrating examples of methods for determining the black-component upper limit value and the extra-color-component upper limit value or, in addition thereto, the black-component lower limit value and the extra-color-component lower limit value. The black-component upper limit value supK and the black-component lower limit value infK are values in the case in which the value of the extra-color component is minimized. Accordingly, regarding the black-component upper limit value supK, the model that converts L*a*b* values into the black-component upper limit value supK may be generated using multiple pairs of L*a*b* values and the maximum value supK of the black component included in colors represented by the L*a*b* values in the case which is illustrated in FIG. 2D that is re-illustrated in FIG. 6C and in which the value of the extra-color component is minimized and the black component is maximized. Additionally, also regarding the black-component lower limit value infK, the model that converts L*a*b* values into the black-component lower limit value infK may be generated using multiple pairs of L*a*b* values and the minimum value infK of the black component included in colors represented by the L*a*b* values in the case which is illustrated in FIG. 2C that is re-illustrated in FIG. 6B and in which the value of the extra-color component and the black component are minimized.

Also regarding the extra-color-component upper limit value supS, the model that converts L*a*b* values into the extra-color-component upper limit value supS may be generated using multiple pairs of L*a*b* values and the maximum value supS of the extra-color component included in colors represented by the L*a*b* values in the case which is illustrated in FIG. 2B that is re-illustrated in FIG. 6A and in which the value of the extra-color component and the black component are maximized. Moreover, also regarding the extra-color-component lower limit value infS, the model that converts L*a*b* values into the extra-color-component limit value infS may be generated using multiple pairs of L*a*b* values and the minimum value infS of the extra-color component included in colors represented by the L*a*b* values in the case which is illustrated in FIG. 2C that is re-illustrated in FIG. 6B and in which the value of the extra-color component and the black component are minimized or the case which is illustrated in FIG. 2D that is re-illustrated in FIG. 6C and in which the value of the extra-color component is minimized and the black component is maximized.

Note that, when multiple colors are used as extra colors, the extra-color-component upper limit value supS or, in addition thereto, the extra-color-component lower limit value infS are obtained for each of extra-color components of the extra colors. For each of the extra-color components, the extra-color-component-value determination unit 14 determines a value of the extra-color component so that the value of the extra-color component is in the range of the extra-color-component upper limit value supS or less or in the range of the extra-color-component lower limit value infS to the extra-color-component upper limit value supS. The methods for determining the black-component upper limit value and the extra-color-component upper limit value or, in addition thereto, the black-component lower limit value and the extra-color-component lower limit value from, for example, L*a*b* values, as described above, are methods that are used to determine a black-component maximum value, a black-component minimum value, and an extra-color-component minimum value, for example, also in the related art. In the related art, a value of the black component is used to determine an extra-color-component maximum value. Accordingly, the extra-color-component maximum value is determined using a model that addresses the input/output characteristic model of an output device in an inverse manner. It is possible to obtain the extra-color-component upper limit value supS with computational complexity which is lower than that in the case of using the model.

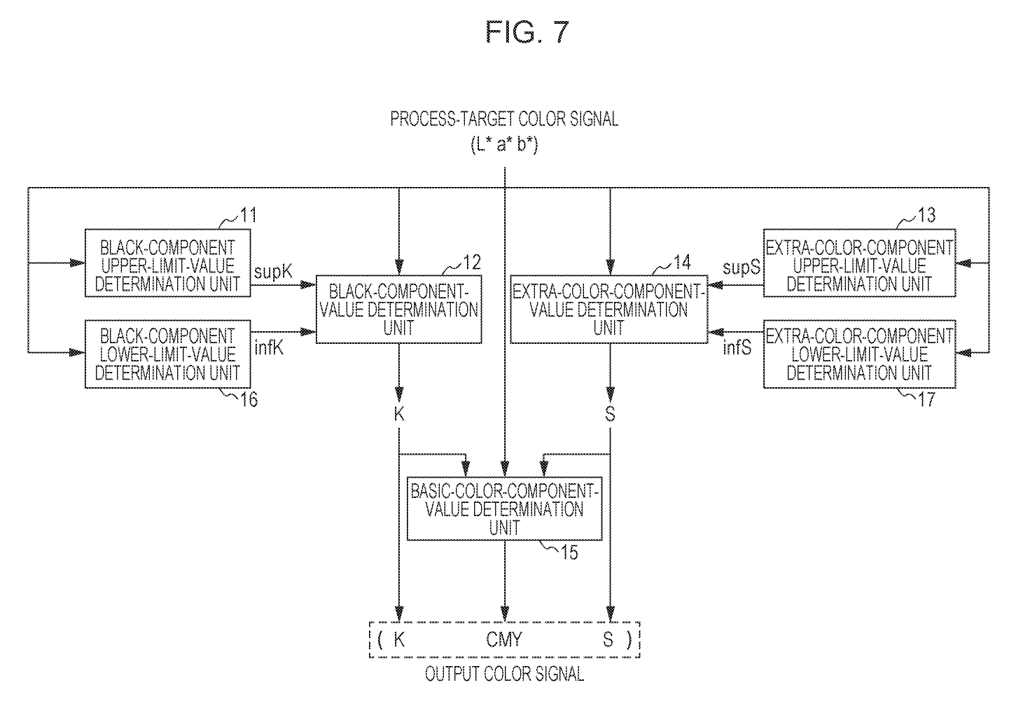

FIG. 7 is a configuration diagram illustrating a first modification example of the exemplary embodiment of the present invention. In this first modification example, an example of a configuration in a case of using the black-component lower limit value infK and the extra-color-component lower limit value infS, which are described above, is described. A black-component lower-limit-value determination unit 16 determines, as the black-component lower limit value, a minimum value of the black component in the case in which the extra-color component is minimized. The black-component lower limit value may be determined using, for example, a method using the corresponding model described above. Alternatively, the black-component lower limit value may be determined using another search method or the like. The black-component-value determination unit 12 determines a value of the black component using the black-component lower limit value, which has been determined by the black-component lower-limit-value determination unit 16, together with the black-component upper limit value supK, which has been determined by the black-component upper-limit-value determination unit 11, so that the value of the black component is in the range of the black-component lower limit value infK to the black-component upper limit value supK.

Furthermore, an extra-color-component lower-limit-value determination unit 17 determines, as the extra-color-component lower limit value, a minimum value of the extra-color component in the case in which the value of the black component is minimized while the extra-color component is being used. The extra-color-component lower limit value may also be determined using, for example, a method using the corresponding model described above. Alternatively, the extra-color-component lower limit value may be determined using another search method or the like. The extra-color-component-value determination unit 14 determines a value of the extra-color component using the extra-color-component lower limit value infS, which has been determined by the extra-color-component lower-limit-value determination unit 17, together with the extra-color-component upper limit value supS, which has been determined by the extra-color-component upper-limit-value determination unit 13, so that the value of the extra-color component is in the range of the extra-color-component lower limit value infS to the extra-color-component upper limit value supS.

In this manner, the black-component upper limit value supK or, in addition thereto, the black-component lower limit value infK are determined, and the black-component-value determination unit 12 controls the value of the black component so that the value of the black component is in the range of the black-component upper limit value supK or less or in the range of the black-component lower limit value infK to the black-component upper limit value supK. Furthermore, the extra-color-component upper limit value supS or, in addition thereto, the extra-color-component lower limit value infS are determined, and the extra-color-component-value determination unit 14 controls the value of the extra-color component so that the value of the extra-color component is in the range of the extra-color-component upper limit value supS or less or in the range of the extra-color-component lower limit value infS to the extra-color-component upper limit value supS. In this case, the value of the black component and the value of the extra-color component are controlled independently of each other. Problems in a case of color reproduction are more easily addressed by such independent control, compared with addressing of those in the related art.

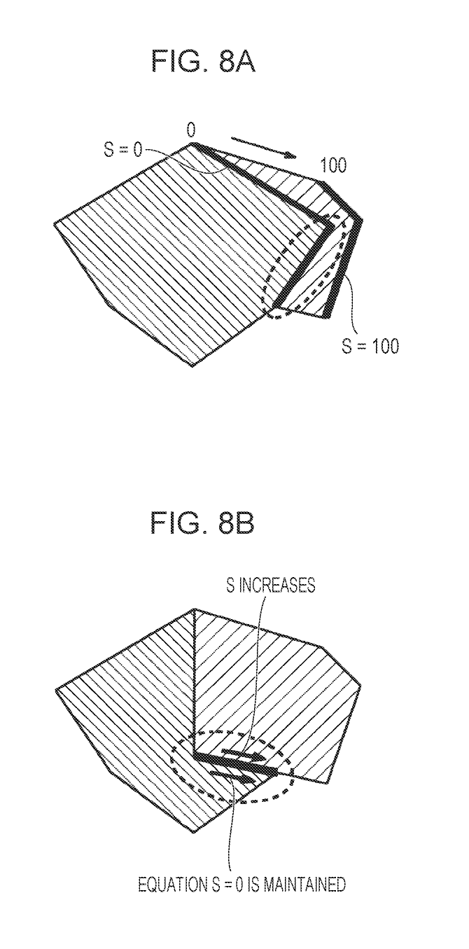

FIGS. 8A and 8B are explanatory diagrams illustrating examples of problems with color continuity, which are caused by values of the extra-color component. The example illustrated in FIG. 8A is an example of the case which is illustrated in FIG. 2D and in which the black component is maximized and the extra-color component is minimized. In the example, in a case in which the color changes from a color in a region in which the value of the extra-color component is zero to a color in a region including the extra-color component, the value of the extra-color component changes in a color region from a boundary that is indicated by a bold line so as to represent an equation S=0 and to the color gamut boundary that is indicated by a bold line so as to represent an equation S=100. Accordingly, color continuity needs to be ensured at the boundary portion, which is surrounded with the broken line in FIG. 8A, between the region in which the value of the extra-color component is zero and the region including the extra-color component.

Additionally, the example illustrated in FIG. 8B is an example of the case which is illustrated in FIG. 2B and in which both the black component and the extra-color component are maximized. In the example, the value of the extra-color component changes in a color region from an achromatic color axis to the color gamut boundary. Accordingly, color continuity is better than that in the example illustrated in FIG. 8A. However, in a color region surrounded with the broken line in FIG. 8B, although the value of the extra-color component changes on the side of the region including the extra-color component, the value of the extra-color component is held at zero on the side of the region that does not include the extra-color component. Thus, a problem occurs in color continuity.

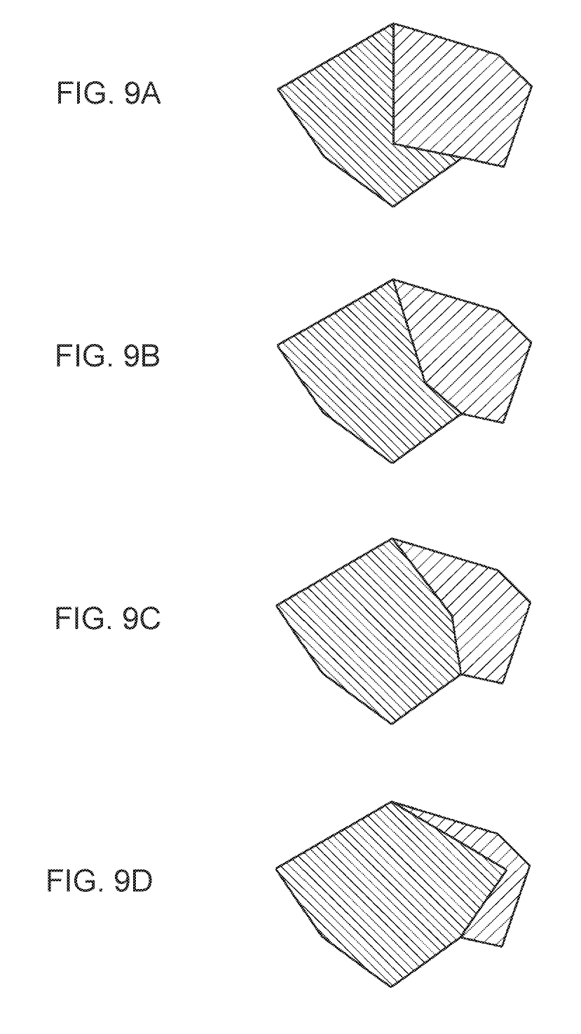

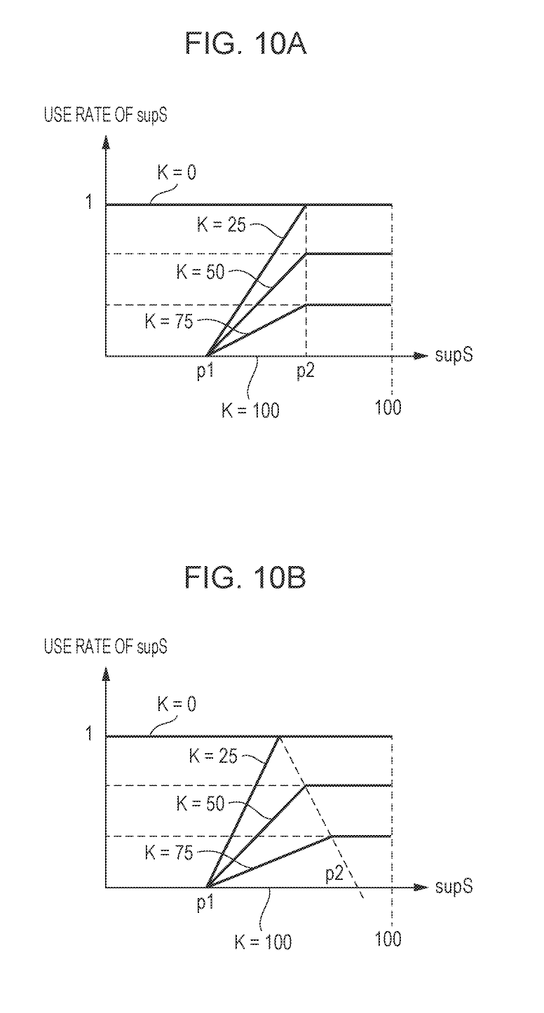

FIGS. 9A to 9D are explanatory diagrams illustrating examples of control of the black component and the extra-color component that is performed so as to guarantee color continuity. Similarly, FIGS. 10A and 10B are explanatory diagrams illustrating examples of functions that control the value of the extra-color component. The problems of color continuity illustrated in FIGS. 8A and 8B are addressed by controlling the black component and the extra-color component. For example, the value of the extra-color component may be controlled by a function in which the value of the extra-color component decreases with increasing value of the black component.

FIG. 9A illustrates the case which is illustrated in FIG. 8B and in which both the black component and the extra-color component are maximized. FIG. 9D illustrates the case which is illustrated in FIG. 8A and in which the black component is maximized and the extra-color component is minimized. The position at which the value of the extra-color component starts increasing is controlled by controlling the extra-color component so that the value of the extra-color component is in the range of the extra-color-component lower limit value to the extra-color-component upper limit value, for example, as illustrated in FIG. 9B or 9C.

For example, in a function illustrated in FIG. 10A, the value of the black component ranges from 0 to 100. The value of the extra-color component S becomes the extra-color-component upper limit value supS when an equation K=0 is satisfied, and becomes the extra-color-component lower limit value infS when an equation K=100 is satisfied. The value of the extra-color-component upper limit value supS is controlled in accordance with the value of the extra-color-component upper limit value supS itself and the black component K as illustrated in FIG. 10A. Note that p1 and p2 are coefficients for controlling the degree of increase in the value of the extra-color component. Note that a relationship p1<p2 is satisfied.

Moreover, the coefficients p1 and p2 may be changeable in accordance with the black component K. The example of a function illustrated in FIG. 10B is an example in which the coefficient p2 is changed in accordance with the black component K. As a matter of course, the function for controlling the value of the extra-color component is not limited to those in the examples. Any function in which a value is controlled using a coefficient may be used.

When a use rate of the extra-color-component upper limit value is determined, for example, using the function illustrated in FIG. 10A or 10B, the value of the extra-color component S may be determined using the following equation. The use rate is denoted by α.

S=α×supS

Note that, when a relationship S<infS is satisfied, it may be supposed that an equation S=infS is satisfied. Alternatively, if the extra-color lower limit value infS is used, the value of the extra-color component S may be determined using the following equation.

S=α×supS+(1−α)×infS

The use rate of the extra-color-component upper limit value is controlled also using the black component K in the methods for controlling the black component and the extra-color component that are described with reference to FIGS. 9A to 9D and FIGS. 10A and 10B. Accordingly, when the property of the output device, such as an interaction between the black component K and the extra-color component S, is grasped, control of the black component and the extra-color component is performed in accordance with the output device. However, depending on the output device, control of the black component and the extra-color component may not be performed in accordance with the output device. Furthermore, in a case of color reproduction using colorimetry, a change in color may be more naturally reproduced by performing control of the black component and the extra-color component in accordance with at least one of brightness, saturation, and hue in a device-independent color space.

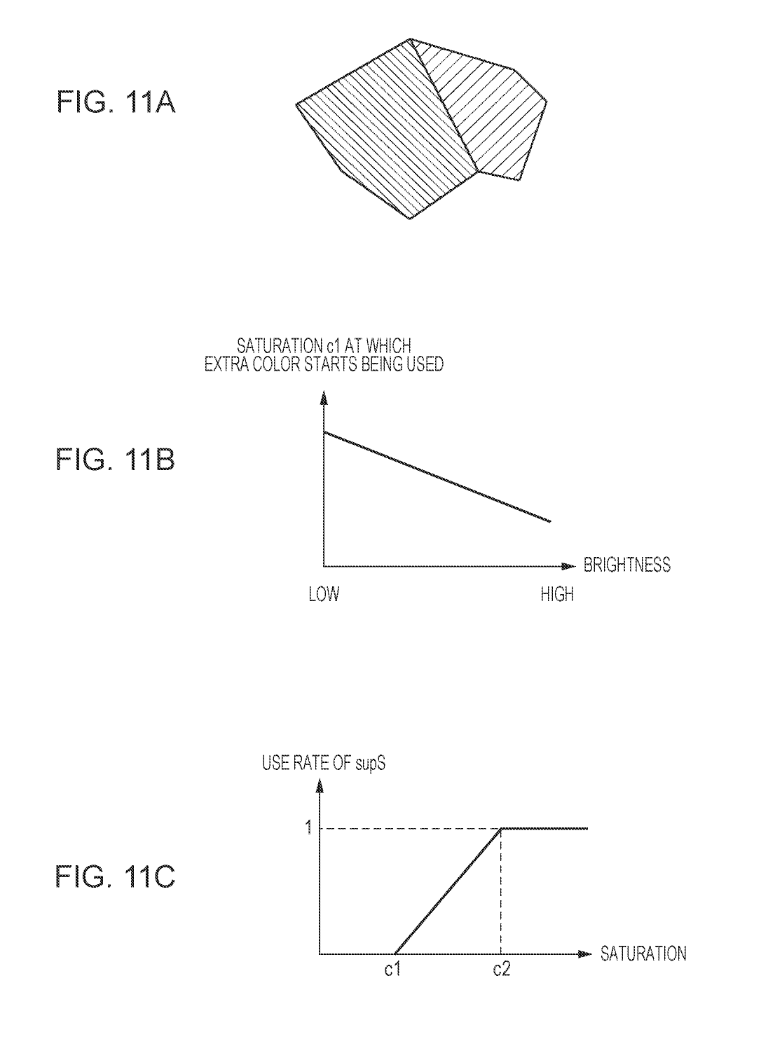

FIGS. 11A to 11C are explanatory diagrams illustrating an example of control of the extra-color component on the basis of brightness. In FIGS. 11A to 11C, a case in which control of the extra-color component is performed in accordance with brightness in a device-independent color space is illustrated. In the example illustrated in FIG. 11B, a saturation c1 at which the extra-color component starts being used is controlled in accordance with brightness. As illustrated in FIG. 11C, the extra-color component starts being used when the saturation is the saturation c1, and is gradually used. The value of the extra-color component becomes the extra-color-component upper limit value supS when the saturation is a saturation c2. Accordingly, a color region using the extra-color component is illustrated as an example in FIG. 11A. As a matter of course, control of the extra-color component may be performed in accordance with saturation, hue, or a combination of brightness, saturation, and hue.

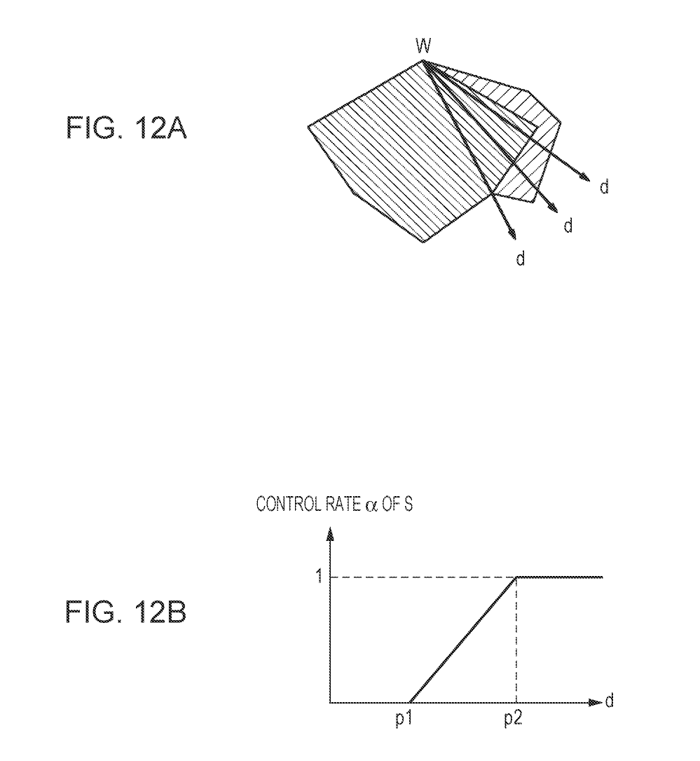

FIGS. 12A and 12B are explanatory diagram illustrating an example of control of the extra-color component on the basis of a distance from a white point. Control of the extra-color component on the basis of the distance from a white point may be performed, as a modification of control of the extra-color component on the basis of brightness, saturation, and hue in a device-independent color space. For example, the value of the extra-color component may be controlled using, for example, a function in which the value of the extra-color component increases with increasing distance from a white point.

In FIG. 12A, a white point is denoted by W. A control rate α that is provided in accordance with a distance d from the white point in each of directions (indicated by the arrows) which extend from the white point serving as a starting point is obtained. For example, in the example illustrated in FIG. 12B, when the distance d from the white point is equal to or larger than zero and equal to or smaller than a coefficient p1, an equation α=0 is satisfied for the control rate α. When the distance d is equal to or larger than the coefficient p1 and equal to or smaller than a coefficient p2, the control rate α is gradually changed. When the distance d is equal to or larger than the coefficient p2, an equation α=1 is satisfied for the control rate α. The position at which the extra-color component starts being used or the change in the value of the extra-color component is controlled by controlling the coefficients p1 and p2. The value of the extra-color component may be obtained using the obtained control rate α and either one of the following equations, which are described above.

S=α×supS

S=α×supS+(1−α)×infS

In any of the examples described with reference to FIGS. 11A to 11C and FIGS. 12A and 12B, color continuity described with reference to FIGS. 8A and 8B is improved, compared with improvement of that in the related art. In the examples described with reference to FIGS. 11A to 11C and FIGS. 12A and 12B, the value of the black component is not used in the case of controlling the extra-color component. Color continuity is realized by performing control of the extra-color component independently of control of the black component.

Control of the black component is also performed by the black-component-value determination unit 12 independently of control of the extra-color component. In the related art, because a value of the black component is determined first, the black component is controlled without depending on the extra-color component. A control method in the related art may be used for control of the black component. Examples of the control method include a method for performing control of the black component in accordance with at least one of brightness, saturation, and hue in a device-independent color space, and a method for performing control of the black component in accordance with the type of image, such as a natural image or a graphic image. As an example of a method for controlling the value of the black component in accordance with brightness and saturation, a control method is considered, in which the value of the black component is made closer to the black-component lower limit value (infK) when the brightness is higher and the saturation is higher, and in which the value of the black component is made closer to the black-component upper limit value (supK) when the brightness is lower and the saturation is lower. As a matter of course, the above-described control of the extra-color component may be used for the black component. Control of the black component on the basis of the distance from a white point may be performed.

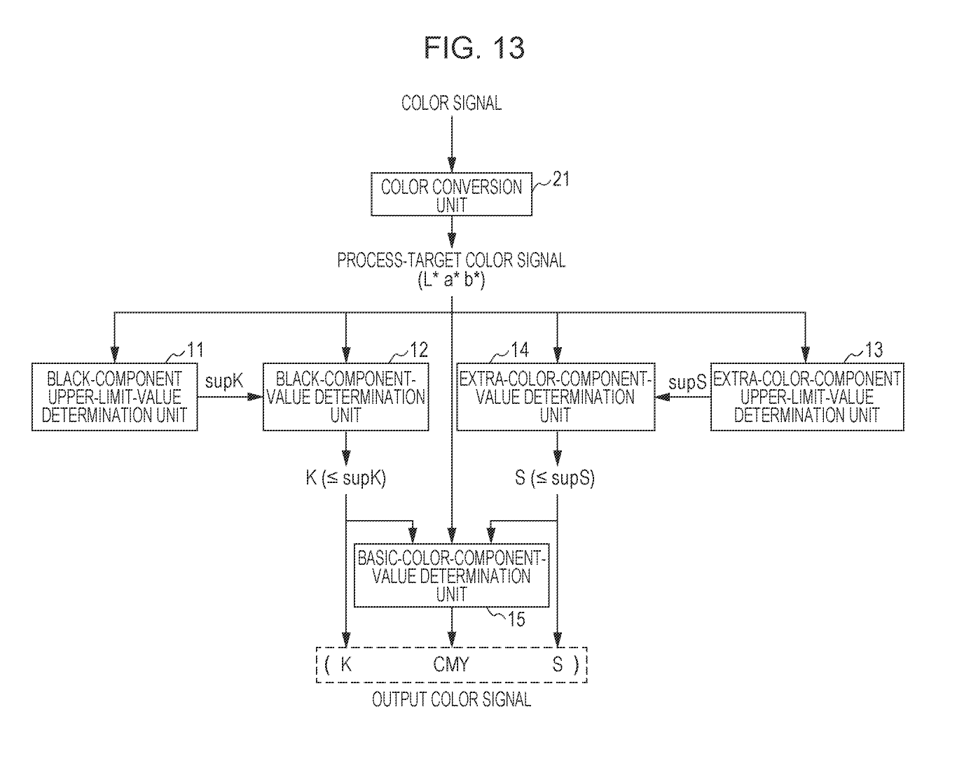

FIG. 13 is a configuration diagram illustrating a second modification example of the exemplary embodiment of the present invention. A case in which a provided color signal is a color signal in a device-independent color space is described above. In the second modification example, a case in which a color signal in a device-dependent color space is provided is described.

A color conversion unit 21 converts a provided color signal in a device-dependent color space into a process-target color signal in a device-independent color space. The LAB color space is provided as an example of the device-independent color space. When a color signal in an RGB color space is provided, conversion from RGB values to L*a*b* values is performed. Alternatively, when a color signal in a CMY color space is provided, conversion from CMY values to L*a*b* values may be performed. As a matter of course, the provided color signal is not limited to any one of the color signals in the color spaces mentioned above. The color space of the process-target color signal is also not limited to the LAB color space. Note that, in a case of color conversion, for example, a color-gamut compression process or the like may be performed in accordance with the color gamut of an output device to which an output color signal is to be output. The process-target color signal that has been obtained using color conversion performed by the color conversion unit 21 is passed on to the black-component-value determination unit 12 and the extra-color-component-value determination unit 14, and an output color signal is determined using the above-described processes.

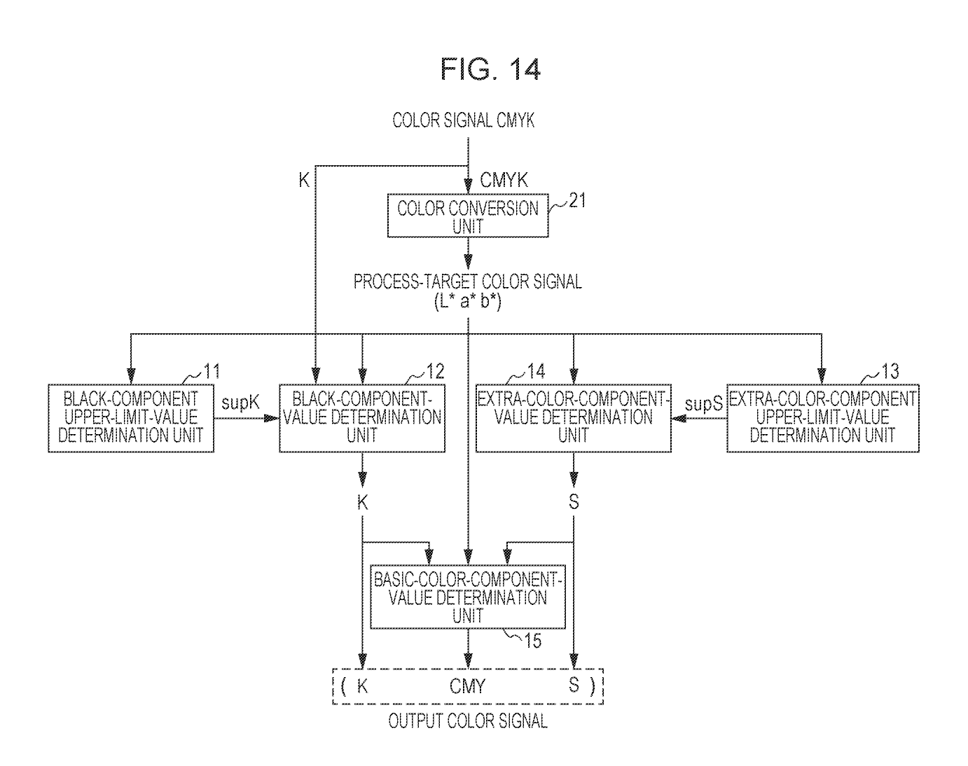

FIG. 14 is a configuration diagram illustrating a third modification example of the exemplary embodiment of the present invention. In the third modification example, an example of a case in which a color signal including the black component is provided is described. A case in which the color signal including the black component is a CMYK color signal is described as a specific example. As a matter of course, a color signal including other extra-color components, such as a CMYKOG color signal or a CMYKRGB color signal, may be provided. The basic-color components are also not limited to CMY.

In the third modification example, a provided value of the black component K, together with the values of the other color components, is provided for the color conversion unit 21, and converted into a process-target color signal in a device-independent color space. Additionally, the value of the black component K is also passed on to the black-component-value determination unit 12.

The black-component-value determination unit 12 obtains a value of the black component so that the value of the black component is in the range of the black-component upper limit value supK or less or in the range of the black-component lower limit value infK to the black-component upper limit value supK. In this case, the provided value of the black component K is used. For example, the value of the black component may be adjusted so as to be in a range defined by the obtained value of the black component and the provided value of the black component. Moreover, when the provided value of the black component is in the range of the black-component upper limit value supK or less or in the range of the black-component lower limit value infK to the black-component upper limit value supK, the provided value of the black component may be determined as a value of the black component of the output color signal. In this case, the value of the black component is preserved. Note that, when the black component and the extra-color component are controlled independently of each other, such control of the black component does not influence control of the extra-color component.

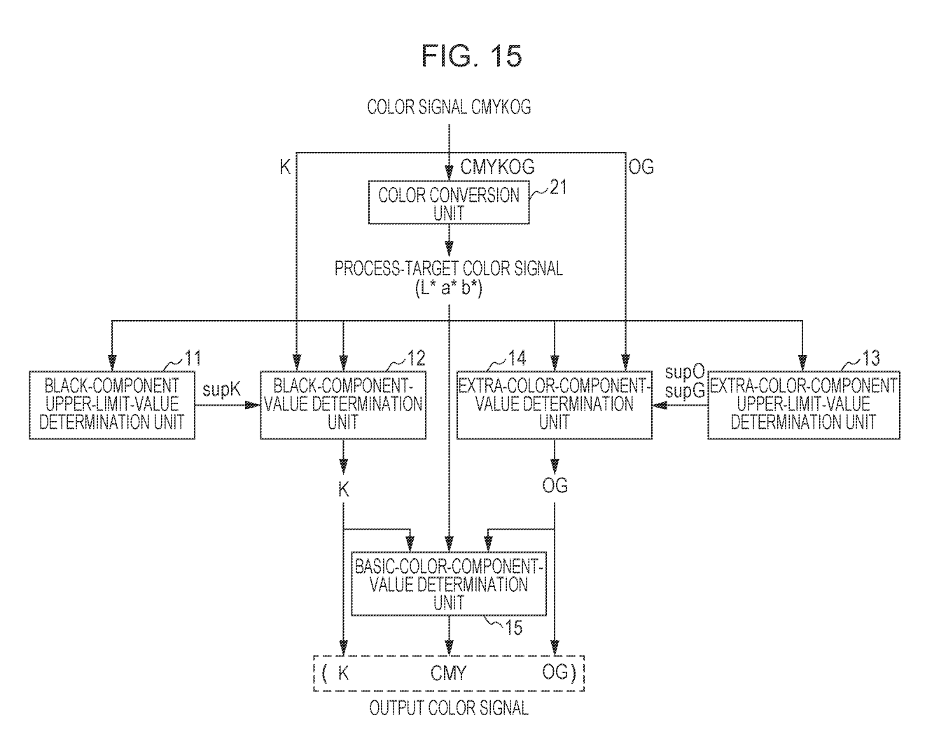

FIG. 15 is a configuration diagram illustrating a fourth modification example of the exemplary embodiment of the present invention. In the fourth modification example, an example of a case in which a color signal including an extra-color component is provided is described. A case in which a CMYKOG color signal including the extra colors O and G is provided is described as a specific example. As a matter of course, a color signal including other extra-color components, such as a CMYKO color signal or a CMYKRGB color signal, may be provided. The basic-color components are also not limited to CMY. Note that, for the black component K, the processes described in the foregoing third modification example may be performed, or a configuration in which a value of the black component is not passed on to the black-component-value determination unit 12 may be provided.

Provided values of the extra-color components O and G, together with the values of the other color components, are provided for the color conversion unit 21, and converted into a process-target color signal in a device-independent color space. Additionally, the values of the extra-color components O and G are also passed on to the extra-color-component-value determination unit 14.

The extra-color-component-value determination unit 14 obtains a value of the extra-color component O so that the value of the extra-color component O is in a range of an extra-color-component upper limit value supO or less or in a range of an extra-color-component lower limit value infO to the extra-color-component upper limit value supO. In this case, the provided value of the extra-color component O is used. For example, the value of the extra-color component O may be adjusted so as to be in a range defined by the obtained value of the extra-color component O and the provided value of the extra-color component O. Moreover, when the provided value of the extra-color component O is in the range of the extra-color-component upper limit value supO or less or in the range of the extra-color-component lower limit value infO to the extra-color-component upper limit value supO, the provided value of the extra-color component O may be determined as a value of the extra-color component O of an output color signal. In this case, the value of the extra-color component is preserved.

The extra-color-component-value determination unit 14 obtains a value of the extra-color component G so that the value of the extra-color component G is in a range of an extra-color-component upper limit value supG or less or in a range of an extra-color-component lower limit value infG to the extra-color-component upper limit value supG. In this case, the provided value of the extra-color component G is used. For example, the value of the extra-color component G may be adjusted so as to be in a range defined by the obtained value of the extra-color component G and the provided value of the extra-color component G. Moreover, when the provided value of the extra-color component G is in the range of the extra-color-component upper limit value supG or less or in the range of the extra-color-component lower limit value infG to the extra-color-component upper limit value supG, the provided value of the extra-color component G may be determined as a value of the extra-color component G of the output color signal. In this case, the value of the extra-color component is preserved.

Note that a configuration may be provided, in which selection of which extra-color component is to be used is performed, or selection of which extra-color component is to be preserved is performed. When the extra-color component and the extra-color component are controlled independently of each other, control of the extra-color components is performed without influencing control of the black component.

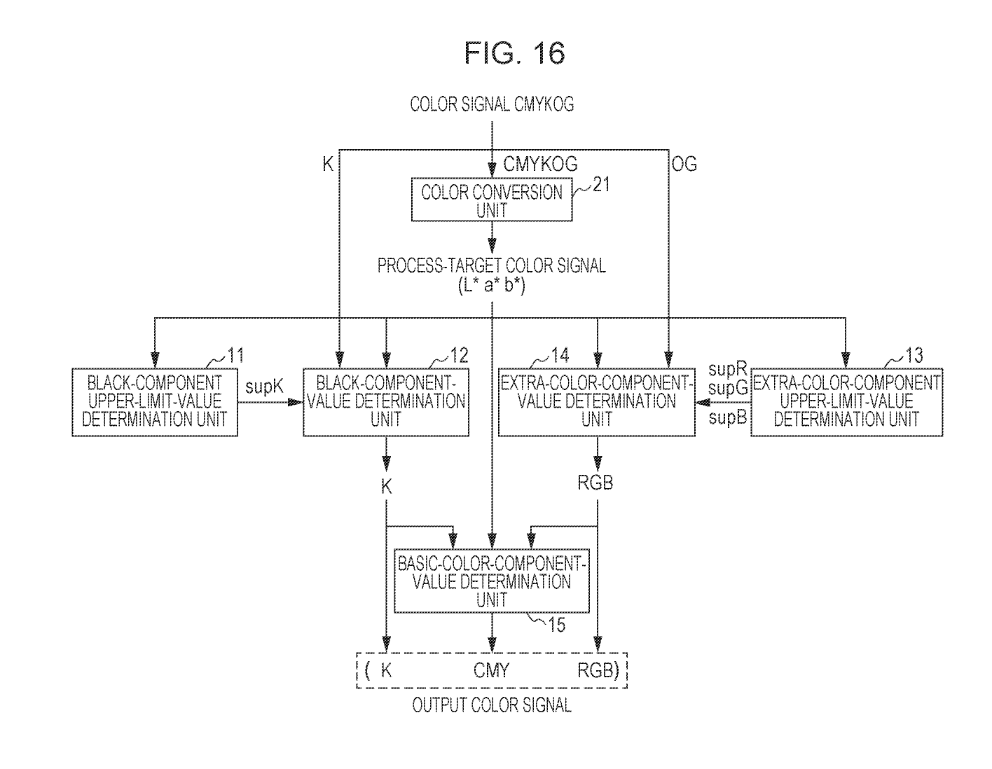

FIG. 16 is a configuration diagram illustrating a fifth modification example of the exemplary embodiment of the present invention. In the fifth modification example, a case in which a color of an extra-color component of a provided color signal and a color of an extra-color component of an output color signal are different from each other is described. A case in which the provided color signal is a CMYKOG color signal including the extra-color components O and G, and in which the output color signal is a CMYKRGB color signal is described as a specific example. As a matter of course, the basic-color components and the extra-color components of both the provided color signal and the output color signal are not limited to those in this example. Note that, also in the fifth modification example, for the black component K, the processes described in the foregoing third modification example may be performed, or a configuration in which a value of the black component is not passed on to the black-component-value determination unit 12 may be provided.

Provided values of the extra-color components O and G, together with values of the other color components, are provided for the color conversion unit 21, and converted into a process-target color signal in a device-independent color space. Additionally, the values of the extra-color components O and G are also passed on to the extra-color-component-value determination unit 14.

The extra-color component G of the provided color signal corresponds to the extra-color component G of the output color signal. Accordingly, for the extra-color component G of the provided color signal, the extra-color-component-value determination unit 14 may perform, for example, control described in the fourth modification example. For the extra-color component O of the provided color signal, no extra-color component O exists in the output color signal. In this case, supposing that a value of one of the extra-color components of the output signal is provided and that a difference between a hue of the extra-color component of the output signal and a hue of the extra-color component O of the provided color signal is the smallest among differences between hues of the extra-color components of the output color signal and the hue of the extra-color component O of the provided color signal, the value of the extra-color component of the output color signal is controlled. In the example, regarding the extra-color component O of the provided color signal, supposing that an extra-color component R of the output signal is provided, the value of the extra-color component O of the provided color signal is used to control the value of the extra-color component R of the output color signal. For example, the value of the extra-color component R may be adjusted so as to be in a range defined by an obtained value of the extra-color component R and the provided value of the extra-color component O. Thus, the value of the extra-color component O of the provided color signal is reflected in the extra-color component R of the output color signal.

Note that, although examples in which the color conversion unit 21 is provided in the configuration illustrated in FIG. 1 are illustrated in FIGS. 13 to 16, as a matter of course, modification in the configuration illustrated in FIG. 7 may be performed as in the above-described examples using the black-component lower limit value and the extra-color-component lower limit value.

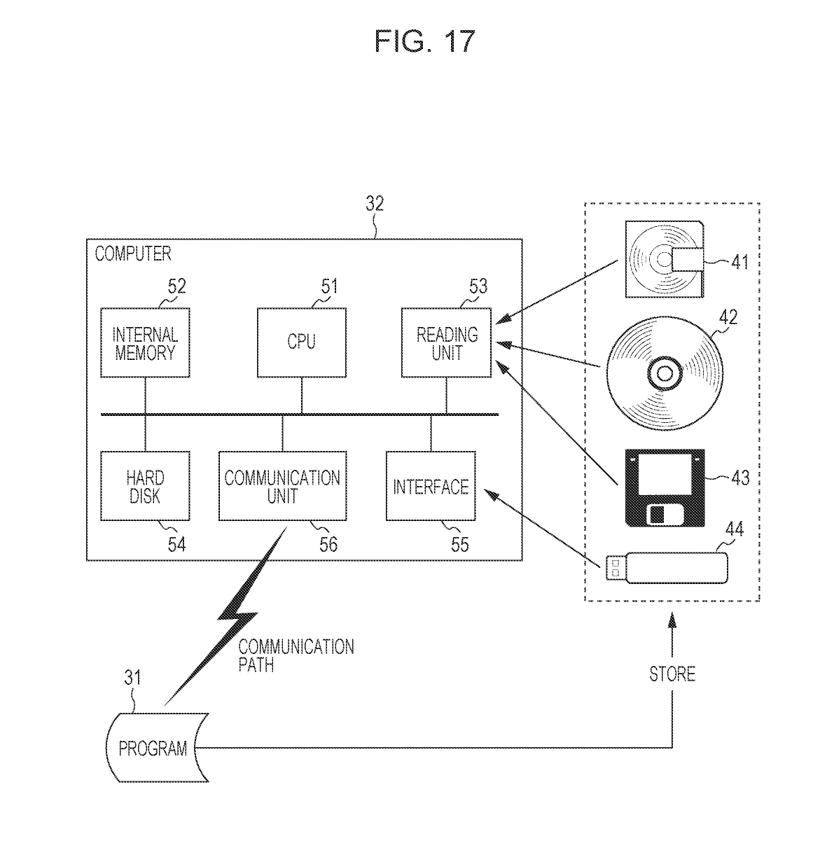

FIG. 17 is an explanatory diagram illustrating examples of a computer program, a storage medium that stores the computer program, and a computer in a case in which functions described in the exemplary embodiment of the present invention and the modification examples of thereof are realized by the computer program.

All or some of the functions of the individual units described in the exemplary embodiment of the present invention and the modification examples thereof which are described above may be realized by a program 31 executed by a computer 32. In this case, the program 31, data used by the program, and so forth may be stored in a computer-readable storage medium. The term “storage medium” refers to a medium that generates a state in which energy, such as magnetic energy, optical energy, or electrical energy, changes in accordance with the content written in a program, and that transmits the content written in the program to a reading unit 53 provided in a hardware resource of the computer 32 in the form of a signal corresponding to a change in the energy. Examples of the storage medium include a magneto-optical disk 41, an optical disk 42 (including a compact disk (CD) and a digital versatile disk (DVD)), a magnetic disk 43, and a memory 44 (including an integrated circuit (IC) card, a memory card, and a flash memory). As a mater of course, the storage medium is not limited to a portable storage medium.

All or some of the functions described in the exemplary embodiment of the present invention and the modification examples thereof which are described above are realized by storing the program 31 in the storage medium, by placing the storage medium in, for example, the reading unit 53 or an interface 55 of the computer 32, by reading the program 31 with the computer 32, by storing the program 31 in an internal memory 52 or a hard disk 54 (including a magnetic disk and a silicon disk), and by executing the program 31 with a central processing unit (CPU) 51. Alternatively, all or some of the functions described in the exemplary embodiment of the present invention and the medication examples thereof which are described above may be realized by transferring the program 31 to the computer 32 via a communication path, by receiving the program 31 with a communication unit 56 in the computer 32, by storing the program 31 in the internal memory 52 or the hard disk 54, and by executing the program 31 with the CPU 51.

The computer 32 may be connected to other various apparatuses via the interface 55. For example, a display that displays information and a receiver that receives information from a user may also be connected to the computer 32. Additionally, for example, an image forming apparatus is connected via the interface 55 to the computer 32, and a configuration in which an image is formed using an output color signal by the image forming apparatus may be provided. Note that individual configurations may not necessarily be implemented as operations that are performed by a single computer, and individual processes may be performed by different computers in accordance with steps of the processes.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A color processing apparatus for performing color decomposition of a color signal into an output color signal, the color signal being input, the output color signal including a basic-color component, a black component, and an extra-color component, the color processing apparatus comprising:
an extra-color-component upper-limit-value determination unit that determines an extra-color-component upper limit value, the extra-color-component upper limit value being a value of the extra-color component corresponding to a maximum value of the black component which is obtainable using the color decomposition of the color signal;
a black-component upper-limit-value determination unit that determines a black-component upper limit value, the black-component upper limit value being a maximum value of the black component corresponding to a minimum value of the extra-color component which is obtainable using the color decomposition of the color signal;
a black-component-value determination unit that determines a value of the black component corresponding to the color signal, the value of the black component being equal to or smaller than the black-component upper limit value;
an extra-color-component-value determination unit that determines a value of the extra-color component corresponding to the color signal, the value of the extra-color component being equal to or smaller than the extra-color-component upper limit value; and
a basic-color-component-value determination unit that determines a value of the basic-color component corresponding to the color signal on the basis of the value of the black component, which has been determined by the black-component-value determination unit, and the value of the extra-color component, which has been determined by the extra-color-component-value determination unit.

2. The color processing apparatus according to claim 1, wherein, in a case in which a first value of the black component corresponding to the color signal is included in the color signal that has been input, and in which the first value of the black component is equal to or smaller than the black-component upper limit value, the black-component-value determination unit uses the first value of the black component as a value of the black component of the output color signal.

3. The color processing apparatus according to claim 1, wherein the black-component-value determination unit determines a value of the black component in accordance with at least one of brightness, saturation, and hue.

4. The color processing apparatus according to claim 1, wherein, in a case in which a first value of the black component corresponding to the color signal is included in the color signal that has been input, the black-component-value determination unit determines a value of the black component of the output color signal so that the value of the black component of the output color signal is in a range which is defined by the first value of the black component and a second value of the black component that has been obtained so as to be in a range of the black-component upper limit value or less.

5. The color processing apparatus according to claim 1, wherein the extra-color-component-value determination unit determines a value of the extra-color component of the output signal in accordance with a distance from a white point in a device-independent color space.

6. The color processing apparatus according to claim 5, wherein the extra-color-component-value determination unit determines a value of the extra-color component using a function in which the value of the extra-color component increases with increasing distance from the white point.

7. The color processing apparatus according to claim 1, wherein the extra-color-component-value determination unit determines a value of the extra-color component using a function in which the value of the extra-color component decreases with increasing value of the black component.

8. The color processing apparatus according to claim 1, wherein the extra-color-component-value determination unit determines a value of the extra-color component in accordance with at least one of brightness, saturation, and hue in a device-independent color space.

9. The color processing apparatus according to claim 1, wherein, in a case in which a first value of the extra-color component corresponding to the color signal is included in the color signal that has been input, and in which the first value of the extra-color component is equal to or smaller than the extra-color-component upper limit value, the extra-color-component-value determination unit uses the first value of the extra-color component as a value of the extra-color component of the output color signal.

10. The color processing apparatus according to claim 1, wherein, in a case in which a first value of the extra-color component corresponding to the color signal is included in the color signal that has been input, the extra-color-component-value determination unit determines a value of the extra-color component of the output color signal so that the value of the extra-color component of the output color signal is in a range which is defined by the first value of the extra-color component and a second value of the extra-color component that has been obtained so as to be in a range of the extra-color-component upper limit value or less.

11. The color processing apparatus according to claim 9,
wherein an extra-color of the extra-color component included in the output color signal includes a plurality of extra colors,
wherein, in a case in which the color signal that has been input includes an extra-color component of a third extra color, and in which the third extra color is different from any one of the plurality of extra colors of the extra-color component included in the output color signal, the extra-color-component-value determination unit uses a value of the extra-color component of the third extra color included in the color signal that has been input as a value of the extra-color component corresponding to one of the plurality of extra colors, a difference between a hue of the third extra color and a hue of the one of the plurality of extra colors being the smallest among differences between the hue of the third extra color and the hues of the plurality of extra colors of the extra-color component included in the output color signal.

12. The color processing apparatus according to claim 10,
wherein an extra color of the extra-color component included in the output color signal includes a plurality of extra colors,
wherein, in a case in which the color signal that has been input includes an extra-color component of a third extra color, and in which the third extra color is different from any one of the plurality of extra colors of the extra-color component included in the output color signal, the extra-color-component-value determination unit uses a value of the extra-color component of the third extra color included in the color signal that has been input as a value of the extra-color component corresponding to one of the plurality of extra colors, a difference between a hue of the third extra color and a hue of the one of the plurality of extra colors being the smallest among differences between the hue of the third extra color and the hues of the plurality of extra colors of the extra-color component included in the output color signal.

13. The color processing apparatus according to claim 1, further comprising a conversion unit that converts a first color signal in a device-dependent color space into a second color signal in a device-independent color space, and that outputs the second color signal as the color signal which is to be input.

14. The color processing apparatus according to claim 1,
wherein the extra-color component of the output color signal includes a plurality of extra-color components,
wherein the extra-color-component upper-limit-value determination unit determines an extra-color-component upper limit value of each of the plurality of extra-color components, and
wherein the extra-color-component-value determination unit determines a value of each of the plurality of extra-color components so that the value of the extra-color component is in a range of a corresponding one of the extra-color-component upper limit values or less.

15. A color processing method for performing color decomposition of a color signal into an output color signal, the color signal being input, the output color signal including a basic-color component, a black component, and an extra-color component, the color processing method comprising:
determining an extra-color-component upper limit value that is a value of the extra-color component corresponding to a maximum value of the black component which is obtainable using the color decomposition of the color signal;
determining a black-component upper limit value that is a maximum value of the black component corresponding to a minimum value of the extra-color component which is obtainable using the color decomposition of the color signal;
determining a value of the black component corresponding to the color signal, the value of the black component being equal to or smaller than the black-component upper limit value;
determining a value of the extra-color component corresponding to the color signal, the value of the extra-color component being equal to or smaller than the extra-color-component upper limit value; and
determining a value of the basic-color component corresponding to the color signal on the basis of the determined value of the black component and the determined value of the extra-color component.

16. A computer-readable non-transitory tangible medium storing a program causing a computer to execute a process for serving as a processing section of a color processing apparatus so as to perform color decomposition of a color signal into an output color signal, the color signal being input, the output color signal including a basic-color component, a black component, and an extra-color component,
the color processing apparatus comprising:
an extra-color-component upper-limit-value determination unit that determines an extra-color-component upper limit value, the extra-color-component upper limit value being a value of the extra-color component corresponding to a maximum value of the black component which is obtainable using the color decomposition of the color signal;
a black-component upper-limit-value determination unit that determines a black-component upper limit value, the black-component upper limit value being a maximum value of the black component corresponding to a minimum value of the extra-color component which is obtainable using the color decomposition of the color signal;
a black-component-value determination unit that determines a value of the black component corresponding to the color signal, the value of the black component being equal to or smaller than the black-component upper limit value;
an extra-color-component-value determination unit that determines a value of the extra-color component corresponding to the color signal, the value of the extra-color component being equal to or smaller than the extra-color-component upper limit value; and
a basic-color-component-value determination unit that determines a value of the basic-color component corresponding to the color signal on the basis of the value of the black component, which has been determined by the black-component-value determination unit, and the value of the extra-color component, which has been determined by the extra-color-component-value determination unit.
